(19) United States
(12) Patent Application Publication
(10) Pub. No.: US 2014/0043375 A1
(43) Pub. Date: Feb. 13, 2014

(54) DRIVING APPARATUS OF LIQUID CRYSTAL DISPLAY PANEL

(71) Applicant: Novatek Microelectronics Corp., Hsinchu (JP)

(72) Inventor: Yi-Nung Hu, Kaohsiung City (TW)

(73) Assignee: Novatek Microelectronics Corp., Hsinchu (JP)

(21) Appl. No.: 13/953,761

(22) Filed: Jul. 30, 2013

(30) Foreign Application Priority Data
Aug. 13, 2012 (TW) 101129230

(51) Int. Cl. G09G 3/36

(52) U.S. Cl. CPC G09G 3/36
USPC 345/690; 345/204

(57) ABSTRACT

A driving apparatus of a liquid crystal display (LCD) panel including a source driving unit and a channel selection unit is provided. The source driving unit is configured to drive the LCD panel and includes a plurality of data driving channels and at least one dummy driving channel. The channel selection unit is coupled to the source driving unit. The channel selection unit outputs driving signals of a part of the data driving channels and the at least one dummy driving channel to drive the LCD panel based on a testing result under a normal operation. Alternatively, the channel selection unit outputs the driving signals of the data driving channels to drive the LCD panel based on the testing result under the normal operation.

### CROSS-REFERENCE TO RELATED APPLICATION

This application claims the priority benefit of Taiwan application serial no. 101129230, filed on Aug. 13, 2012. The entirety of the above-mentioned patent application is hereby incorporated by reference herein and made a part of this specification.

### BACKGROUND OF THE INVENTION

1. Field of the Invention

The invention generally relates to a driving apparatus, and more particularly to a driving apparatus of a liquid crystal display (LCD) panel.

2. Description of Related Art

A source driving device is a key element for a thin film transistor liquid crystal display (TFT LCD). The source driving device converts digital latch data required for image displaying into analog voltage, and outputs to a pixel array of the TFT LCD, on which images corresponding to the digital latch data are displayed.

Generally, the source driving device usually includes a plurality of data driving channels which are configured to converts the digital latch data required for image displaying into the analog voltage. However, during the fabrication process, it is difficult to ensure that each electric device in each of the data driving channels such as the output amplifier, the digital-to-analog converter, or the latch circuit located in the front end thereof has no defect. If one of the electric devices fails, the source driving device may accordingly output an erroneous driving signal. This kind of failed source driving device may be selected and abandoned at the testing stage, such that the yield rate may be reduced.

### SUMMARY OF THE INVENTION

The invention is directed to a driving apparatus of an LCD panel having a repair function which is capable of enhancing a yield rate of the driving apparatus.

The invention is directed to a driving apparatus of an LCD panel including a source driving unit and a channel selection unit. The source driving unit is configured to drive the LCD panel and includes a plurality of data driving channels and at least one dummy driving channel. The channel selection unit is coupled to the source driving unit. The channel selection unit outputs driving signals of an adjacent part of the data driving channels and the dummy driving channel based on a testing result under a normal operation. Alternatively, the channel selection unit outputs the driving signals of the data driving channels to drive the LCD panel based on the testing result under the normal operation.

In an embodiment of the invention, based on the testing result, when at least one of the data driving channels fails, the channel selection unit outputs the driving signals of the adjacent part of the data driving channels and the dummy driving channel to drive the LCD panel under the normal operation.

In an embodiment of the invention, based on the testing result, based on the testing result, when the data driving channels do not fail, the channel selection unit outputs the driving signals of the data driving channels to drive the LCD panel under the normal operation.

In an embodiment of the invention, the source driving unit includes M data driving channels and N dummy driving channels. The channel selection unit outputs the driving signals of the M-N data driving channels and the N dummy driving channels to drive the LCD panel. Herein, M and N are positive integers, and M>N

In an embodiment of the invention, N=1.

In an embodiment of the invention, the channel selection unit a plurality of selector units. Each of the selector units is coupled to at least two corresponding driving channels of the data driving channels and the dummy driving channel and configured to output one of the driving signals of the two driving channels.

In an embodiment of the invention, for each of the channel selection units, when one of the two driving channels coupled thereto fails, each of the channel selection units outputs the driving signal of the other driving channel.

In an embodiment of the invention, for each of the channel selection units, the two driving channels coupled thereto are adjacent to each other.

In an embodiment of the invention, a number of the driving channels coupled to each of the channel selection units is determined according to a number of the dummy driving channels disposed in the source driving unit.

In an embodiment of the invention, the driving apparatus further includes a digital circuit unit. The digital circuit unit is coupled to the source driving unit and provides at least one dummy driving data to damaged data driving channels of the data driving channels to drive the LCD panel based on the testing result under the normal operation.

In an embodiment of the invention, based on the testing result, the digital circuit unit further provides a plurality of digital driving data to an undamaged part of the data driving channels and the dummy driving channel to drive the LCD panel under the normal operation.

In an embodiment of the invention, the driving apparatus further includes a digital circuit unit. The digital circuit unit is coupled to the source driving unit and provides a plurality of digital driving data to the data driving channels to drive the LCD panel based on the testing result under the normal operation.

In an embodiment of the invention, the driving apparatus further includes a gamma circuit unit. The gamma circuit unit is coupled to the source driving unit and provides a plurality of gamma voltage signals to the data driving channels and the at least one dummy driving channel.

Based on the above, in exemplary embodiments of the invention, the driving apparatus of the LCD panel includes one dummy driving channel. This dummy driving channel may replace the damaged data driving channel to drive the LCD panel under the normal operation.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic circuit diagram of a driving apparatus according to an embodiment of the invention.

FIG. 2 illustrates a schematic circuit diagram of the driving apparatus of FIG. 1, wherein one of the data driving channels fails.

### DETAILED DESCRIPTION OF DISCLOSED EMBODIMENTS

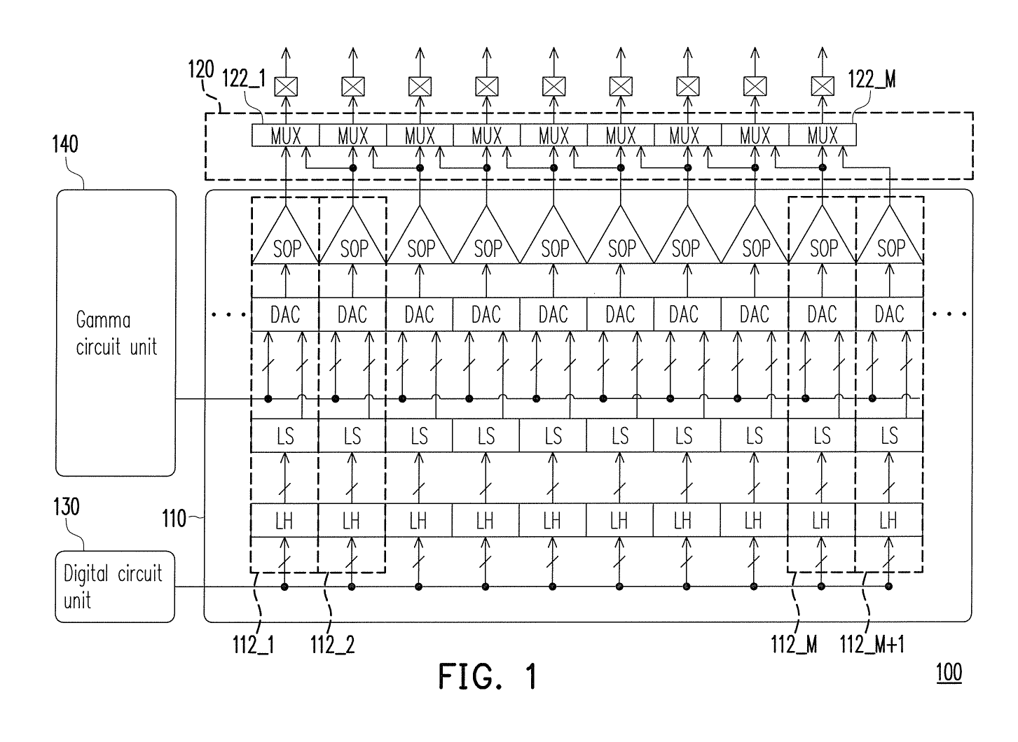

FIG. 1 illustrates a schematic circuit diagram of a driving apparatus according to an embodiment of the invention. Referring to FIG. 1, a driving apparatus 100 of the present embodiment includes a source driving unit 110, a channel selection unit, a digital circuit unit 130, and a gamma circuit unit 140. The source driving unit 110 includes a plurality of data driving channels 112_1 to 112_M and a dummy driving channel 112_M+1 and is configured to drive an LCD panel (not shown). The channel selection unit 120 is coupled to the source driving unit 110 and configured to output driving signals of the data driving channels 112_1 to 112_M or the dummy driving channel 112_M+1 to drive the LCD panel.

After circuit testing, when the data driving channels 112_1 to 112_M do not fail, the channel selection unit 120 may output the driving signals of the data driving channels 112_1 to 112_M to drive the LCD panel under a normal operation. On the contrary, when one of the data driving channels 112_1 to 112_M fails, the channel selection unit 120 may output the driving signals of the undamaged data driving channels and the dummy driving channel 112_M+1 to drive the LCD panel under the normal operation. In this case, the dummy driving channel is configured to replace the damaged data driving channel to drive the LCD panel. Herein, the damaged data driving channel means a data driving channel which outputs an erroneous signal under the normal operation.

In exemplary embodiments of the invention, the driving apparatus 100 working under the normal operation contrasts relative to it working under the circuit testing. In addition, the driving apparatus 100 of the present embodiment, for example, may be applied to drive an LCD panel with a medium or small size. In this embodiment, the driving apparatus of the LCD panel may be integrated into a chip, and thus the circuit testing method includes a chip probe test method.

Specifically, each of the data driving channels 112_1 to 112_M and the dummy driving channel 112_M+1 of the present embodiment includes an output amplifier SOP, a digital-to-analog converter DAC, a level shifter LS, and a latch circuit LH. The latch circuit LH is configured to store and latch digital driving data provided by the digital circuit unit 130. The level shifter LS is configured to transmit the received digital driving data and adjust voltage levels of the digital driving data. The digital-to-analog converter DAC is configured to select gamma voltages and convert them into analog driving signals based on the digital driving data and gamma voltage signals provided by the gamma circuit unit 140. The output amplifier SOP is configured to receive the analog driving signals and increase the driving capacity thereof, and then outputs them out of the driving channel to drive the LCD panel.

On the other hand, the channel selection unit 120 of the present embodiment includes a plurality of selector units 122_1 to 122_M. Herein, each of the selector units, for example, may be a 2 to 1 selector which is configured to output the driving signal of one of the two driving channels. Each of the selector units is coupled to corresponding two driving channels among the data driving channels 112_1 to 112_M and the dummy driving channel 112_M+1. For example, the selector unit 122_1 has two input terminals respectively coupled to the data driving channels 112_1 and 112_2, and the selector unit 122_M has two input terminals respectively coupled to the data driving channel 112_M and the dummy driving channel 112_M+1. The connection relationship of the other selector units 122_2 to 122_M+1 and the corresponding data driving channels is shown as FIG. 1, and it can be deduced from the above description and will not be described again herein. In this case, the two data driving channels coupled to each of the selector units are neighboring with each other, and the invention is not limited thereto.

Furthermore, a single dummy driving channel 112_M+1 disposed in the source driving unit 110 is exemplary for description, and thus each of the selector units has two input terminals respectively coupled to the driving channels, but the invention is not limited thereto. In other embodiments, based on the design requirement, a plurality of dummy driving channels may be disposed in the source driving unit 110 to replace damaged data driving channels to drive the LCD panel when a plurality of data driving channels are damaged. In this case, a number of the driving channels coupled to each of the channel selection units is determined according to a number of the dummy driving channels disposed in the source driving unit. For example, if there are two dummy driving channels disposed in the source driving unit, each of the selector units may be designed to have three input terminals respectively coupled to three different data driving channels.

Accordingly, in the present embodiment, based on the testing result of the driving apparatus 100 at the testing stage, when the data driving channels do not fail, the channel selection unit 120 outputs the driving signals of the data driving channels 112_1 to 112_M to drive the LCD panel under the normal operation. In this case, since the dummy driving channel 112_M+1 is not used to replace the data driving channel, the designer, for example, may disconnect the power supply path of the dummy driving channel 112_M+1 to reduce the power consumption of the dummy driving channel 112_M+1.

In an embodiment where the data driving channels do not fail, the digital circuit unit 130 provides a plurality of digital driving data to the data driving channels 112_1 to 112_M to drive the LCD panel under the normal operation. The gamma circuit unit 140 provides a plurality of gamma voltage signals to the data driving channels 112_1 to 112_M, so as to provide gamma voltages to each of the digital-to-analog converters DAC for selecting.

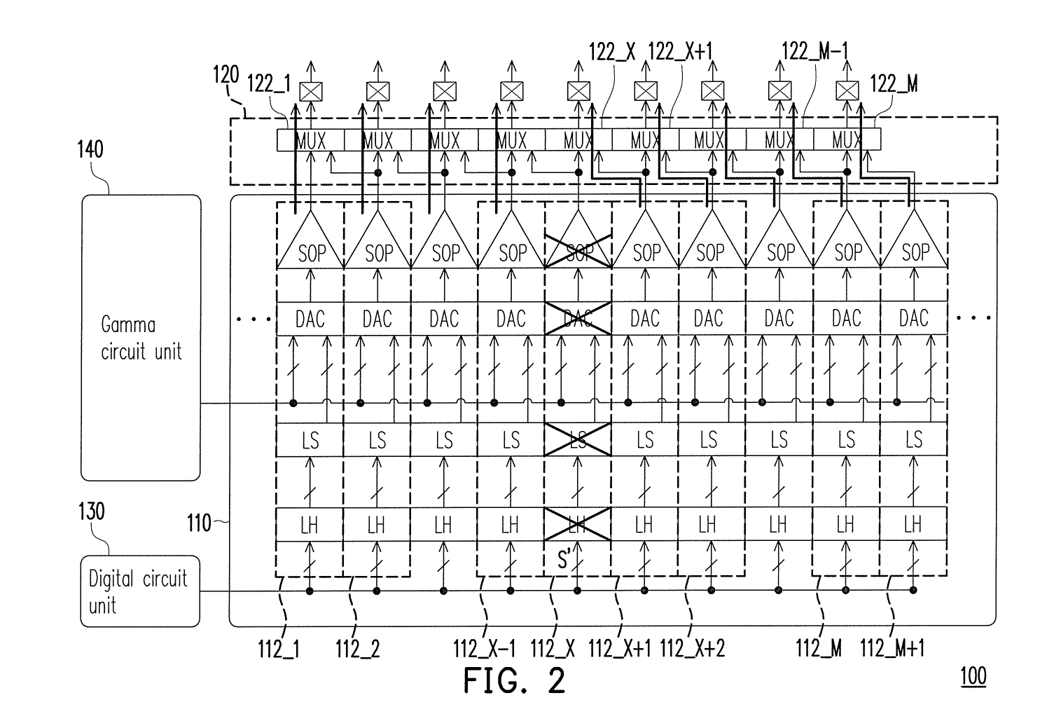

FIG. 2 illustrates a schematic circuit diagram of the driving apparatus of FIG. 1, wherein one of the data driving channels fails. Referring to FIG. 2, after the driving apparatus 100 has been tested, the testing result may show which one of the data driving channels fails. The information may be written into a register, such that the digital circuit unit 130 may determine the location of the damaged data driving channel based on the information written into the register. Next, the digital circuit unit 130 outputs a dummy driving data S′ to the damaged data driving channel and correspondingly outputs digital driving data to the undamaged data driving channels under the normal operation.

Specifically, given that the data driving channels 112_X coupled to the selector unit 122_X shows fail after being tested, the selector unit 122_X may output the driving signal of the other data driving channels 112_X+1 coupled thereto to drive the LCD panel under the normal operation. In the meanwhile, the next selector unit 122_X+1 may output the driving signal of the data driving channels 112_X+2 to drive the LCD panel. The signal selection method of the selector units 122_X+2 to 122_M−1 is shown as FIG. 2, and it can be deduced from the above description and will not be described again herein. It should be noted that the selector unit 122_M outputs the driving signal provided by the dummy driving channel 112_M+1 to drive the LCD panel. Therefore, from the overview of the source driving unit 110, the driving signals selected by the selector units 122_X to 122_M are shifted by one driving channel in the signal selection method. That is to say, for the selector unit 122_X, the data driving channel 112_X coupled thereto has failed, and the selector unit 122_X outputs the driving signal of the next data driving channel 112_X+1. Accordingly, the number of the output pads of the driving apparatus 100 which has been repaired may maintain unchanged, and the driving apparatus 100 can pass the test of the testing equipment to achieve the objective of enhancing the yield rate.

At least to cooperate with the signal selection method of the above selection units, the digital circuit unit 130 of the present embodiment also correspondingly changes its signal supply method. That is to say, based on the testing result, the digital circuit unit 130 outputs the dummy driving data S′ to the damaged data driving channel 112_X and outputs the corresponding digital driving data to the undamaged data driving channels 112_1 to 112_X−1 and 112_X+1 to 112_M and the dummy driving channel 112_M+1 under the normal operation. Herein, the dummy driving data S′ may be any digital data.

In the present embodiment, the source driving unit 110 includes M data driving channels and one dummy driving channel, but the invention is not limited thereto. In other embodiments, there may also be N dummy driving channels disposed in the source driving unit 110, wherein M and N are positive integers, and M>N. In this case, the channel selection unit 120 outputs the driving signals of the M-N data driving channels and the N dummy driving channels to drive the LCD panel. Generally, the number of the disposed dummy driving channels may be determined based on the set yield rate. The higher the yield rate is set, the more number of the disposed dummy driving channels are required. Furthermore, the number of the data driving channels M is related to the resolution of the LCD panel to be driven. The higher is the resolution, the more number of the disposed dummy driving channels are required.

In summary, in exemplary embodiments of the invention, the driving apparatus of the LCD panel includes at least one dummy driving channel. If one of the data driving channels shows fail after being tested, the dummy driving channel may replace the damaged data driving channel to drive the LCD panel under the normal operation. Accordingly, the yield rate of the driving apparatus may be effectively enhanced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving apparatus of a liquid crystal display (LCD) panel, comprising:
a source driving unit configured to drive the LCD panel and comprising a plurality of data driving channels and at least one dummy driving channel; and
a channel selection unit coupled to the source driving unit and outputting driving signals of a part of the data driving channels and the at least one dummy driving channel or outputting the driving signals of the data driving channels to drive the LCD panel based on a testing result under a normal operation.

2. The driving apparatus as claimed in claim 1, wherein based on the testing result, when at least one of the data driving channels fails, the channel selection unit outputs the driving signals of the part of the data driving channels and the at least one dummy driving channel to drive the LCD panel under the normal operation.

3. The driving apparatus as claimed in claim 1, wherein based on the testing result, when the data driving channels do not fail, the channel selection unit outputs the driving signals of the data driving channels to drive the LCD panel under the normal operation.

4. The driving apparatus as claimed in claim 1, wherein the source driving unit comprises M data driving channels and N dummy driving channels, the channel selection unit outputs the driving signals of the M-N data driving channels and the N dummy driving channels to drive the LCD panel, wherein M and N are positive integers, and M>N.

5. The driving apparatus as claimed in claim 4, wherein N=1.

6. The driving apparatus as claimed in claim 1, wherein the channel selection unit comprises:
a plurality of selector units, each coupled to at least two corresponding driving channels of the data driving channels and the at least one dummy driving channel and configured to output one of the driving signals of the at least two driving channels.

7. The driving apparatus as claimed in claim 6, wherein for each of the channel selection units, when one of the at least two driving channels coupled thereto fails, each of the channel selection units outputs the driving signal of the other driving channel.

8. The driving apparatus as claimed in claim 6, wherein for each of the channel selection units, the at least two driving channels coupled thereto are adjacent to each other.

9. The driving apparatus as claimed in claim 6, wherein a number of the driving channels coupled to each of the channel selection units is determined according to a number of the at least one dummy driving channel disposed in the source driving unit.

10. The driving apparatus as claimed in claim 1, further comprising:
a digital circuit unit coupled to the source driving unit and providing at least one dummy driving data to at least one damaged data driving channel of the data driving channels to drive the LCD panel based on the testing result under the normal operation.

11. The driving apparatus as claimed in claim 10, wherein based on the testing result, the digital circuit unit further provides a plurality of digital driving data to an undamaged part of the data driving channels and the at least one dummy driving channel to drive the LCD panel under the normal operation.

12. The driving apparatus as claimed in claim 1, further comprising:
a digital circuit unit coupled to the source driving unit and providing a plurality of digital driving data to the data driving channels to drive the LCD panel based on the testing result under the normal operation.

13. The driving apparatus as claimed in claim 1, further comprising:
a gamma circuit unit coupled to the source driving unit and providing a plurality of gamma voltage signals to the data driving channels and the at least one dummy driving channel.
